(19) United States
(12) Patent Application Publication
(10) Pub. No.: US 2011/0096719 A1
(43) Pub. Date: Apr. 28, 2011

(54) METHOD AND DEVICE OF ACQUIRING SATELLITE SIGNALS, CORRESPONDING COMPUTER PROGRAM PRODUCT

(75) Inventor: Carmelo Burgio, Bergamo (IT)

(73) Assignee: STMicroelectronics S.r.I., Agrate Brianza (MI) (IT)

(21) Appl. No.: 12/913,396

(22) Filed: Oct. 27, 2010

(30) Foreign Application Priority Data
Oct. 28, 2009 (IT) TO2009A000831

(51) Int. Cl. H04B 7/216

(52) U.S. Cl. 370/320

(57) ABSTRACT

A correlator may correlate a satellite signal modulated with a pseudo-random binary sequence with a local binary sequence including a given number of samples. The correlation may be performed on a given input sequence of length 2N−1 with respect to versions of the local binary sequence of length N having different phases and defining a search space for the correlation results of the table, organized in a table, wherein the lines of the table may represent the versions of the local binary sequence with different phases. The correlator may be structured to perform the correlation operating on a number N of samples equal to a sub-multiple of the number of samples included in the local binary sequence, by exploring the table according to rhomboidal subsets by operating on subsequent lines with sliding windows having widths equal to N and according to a lexicographical order with a periodic return to a new line.

### FIELD OF THE INVENTION

The present disclosure relates to techniques for acquiring satellite signals, and more particularly, to its possible application to global positioning system (GPS) and Galileo signal receivers.

### BACKGROUND OF THE INVENTION

Techniques for acquiring and processing satellite signals (GPS, Galileo) may be addressed by a scientific and technical literature, as well as patent documents. However, approaches proposed so far have drawbacks concerning the necessary time to carry out the “acquisition” process of satellite signals.

### SUMMARY OF THE INVENTION

In view of the foregoing the need is felt for approaches that allow a reduction time for the acquisition of satellite signals, e.g. when they are modulated by a Code Division Multiple Access (CDMA) technique. Specifically, a need has been felt to reduce the time to carry out the acquisition process of all the signals sent by satellites. This is a particularly meaningful factor in receivers manufactured for the consumer sector (e.g. satellite navigators), especially regarding the availability of receivers with optimal reception of GPS and Galileo signals. The object of the invention is to provide a response to that need.

According to the present embodiments, such an object is achieved by an acquiring method having the features set forth in the claims that follow. The embodiments also relate to a corresponding acquiring device as well as a computer product, loadable into the memory of at least one computer, and comprising software code portions adapted to implement the method steps when the product is run on at least one computer. As used herein, the reference to such a computer product is meant to be equivalent to the reference to a computer readable product, including instructions to control the processing system, to coordinate the execution of the process according to the present embodiments. The reference to “at least one computer” is meant to highlight the possibility that the present embodiments may be carried out in a modular and/or distributed form.

### BRIEF DESCRIPTION OF THE DRAWINGS

The invention will now be described, by way of non-limitative example only, with reference to the enclosed representations, wherein:

FIG. 1 is a diagram of a GPS signal;

FIGS. 2a and 2b are self-correlation and cross-correlation function diagrams, respectively, for GPS satellites;

FIG. 3 is a diagram of a Galileo signal;

FIGS. 4a and 4b are self-correlation and cross-correlation function diagrams, respectively, for Galileo satellites;

FIG. 5 is a block diagram of a portion of a receiver for satellite signals in accordance with the present invention;

FIG. 6 is a more detailed block diagram of the correlator module shown in FIG. 5 in accordance with the present invention;

FIG. 7 is a graph of the search space on which the acquiring device operates in accordance with the present invention;

FIG. 8 is a device including a parallel correlator in accordance with the present invention;

FIG. 9 is an acquiring device comprising a circular correlator in accordance with the present invention;

FIGS. 10, 11, and 12 is the application of a correlation with reduced latency on a numerical example in accordance with the present invention; and

FIG. 13 is a different embodiment of the acquiring device in accordance with the present invention.

### DETAILED DESCRIPTION OF THE PREFERRED EMBODIMENTS

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. The headings provided herein are for convenience only and do not interpret the scope or meaning of the embodiments.

Digital signals used by the GPS (USA) and Galileo (EU) satellite navigation systems are both modulated with a Code Division Multiple Access (CDMA) technique. Prior to the frequency modulation of a sinusoidal carrier wave, the technique involves base-band processing through digital signals to achieve various results, for example, the ability to occupy the same frequency band with several signals. Moreover, the presence of CDMA modulation allows for the calculation of the distance between the satellite and the receiver.

The reasons for the possible choice of this particular modulation may be well-known. The following description focuses on identifying and demodulating such a CDMA signal and to efficiently address the problem of satellite signal acquisition, whether it is generated by the GPS or by the Galileo navigation system.

Both the GPS and the Galileo systems transmit signals of a digital nature, i.e. signals that are encoded on two levels (high and low). For the purposes of the following description may be more suitable to consider such digital signals as encoded on two levels corresponding to the values +1 (high) and −1 (low) instead of the more common 0 and 1.

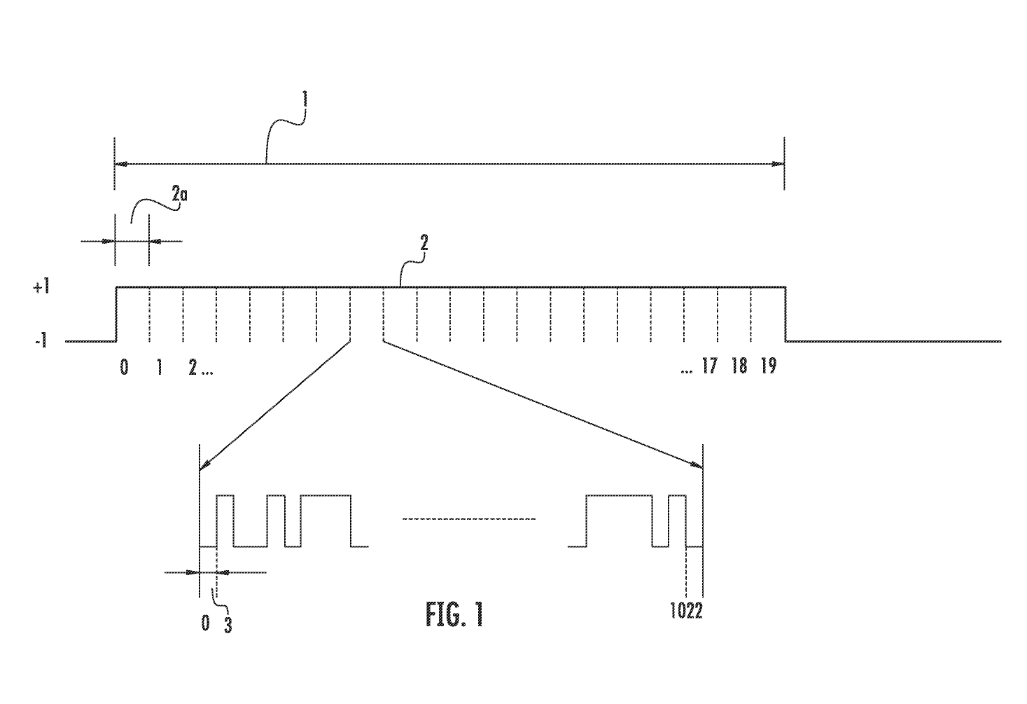

Referring initially to FIG. 1, the base-band signal processing and the way signals of both systems are structured, one information bit of the GPS signal has a period of 20 msec (corresponding to a frequency of 50 Hz), and is denoted with the reference 1. The base-band signal is modulated (i.e. multiplied) with a pseudo-random binary sequence 2 (known as a Coarse Acquisition code (C/A code)), which is periodically repeated and aligned with the data bit. The pseudo-random binary sequence has a period 2a amounting to 1 msec, and it includes 1023 “chips”, wherein the first chip is identified by reference 3; “Chip” is a currently used term to denote the bits that make up C/A codes. Therefore, one GPS data bit is modulated with 20 consecutive sequences of C/A code.

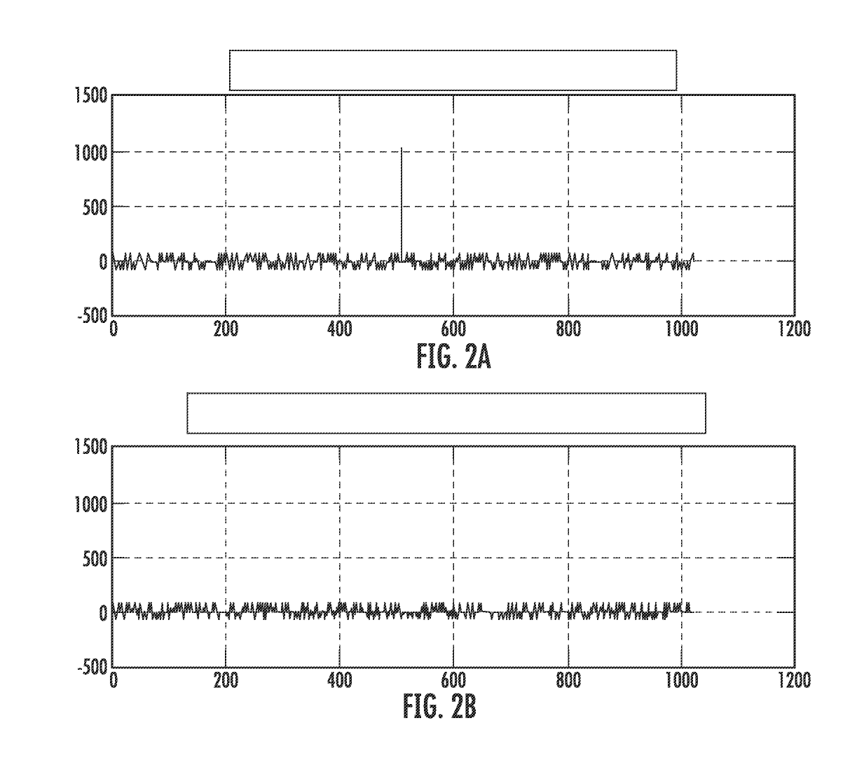

Each GPS satellite is assigned a different C/A code. The codes are selected so that each code has a self-correlation function that is as similar as possible to a Dirac function δ (as illustrated in FIG. 2a), and so that the (cross-) correlation functions of the codes associated with different satellites show very low values (see FIG. 2b).

The receiver, by correlating the received signal with the different C/A codes that are known and uniquely assigned to each transmitter of a satellite, can detect the signal of a satellite on the basis of the presence or the absence of a correlation peak. The receiver comprises a device to perform the signal acquisition. The signal transmitted by the satellites of the Galileo system has a modulation similar in principle to the GPS signal, but showing some differences.

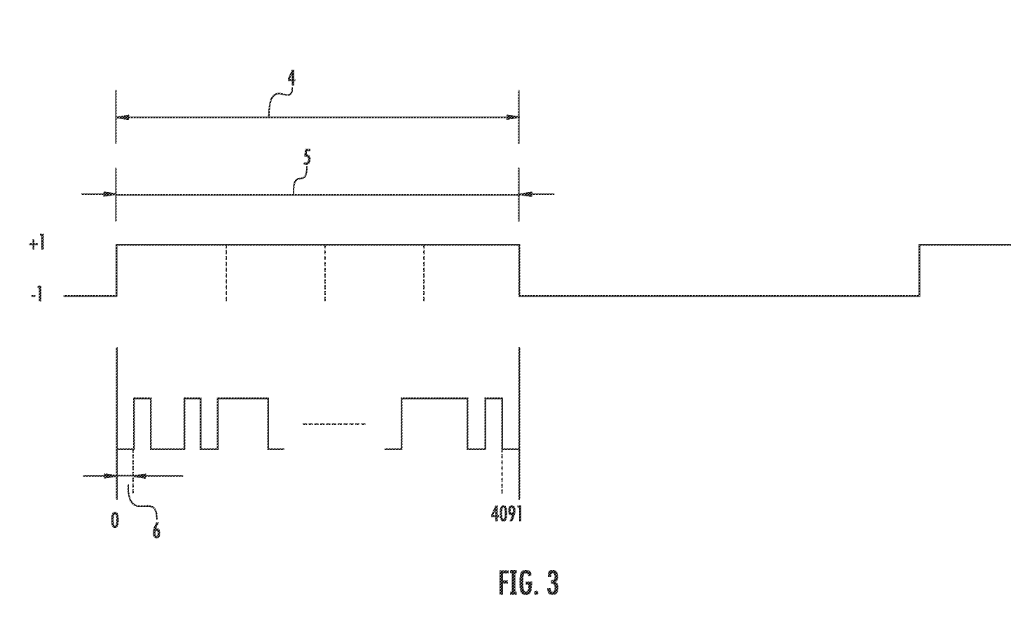

Referring to FIG. 3, a Galileo chip, denoted by reference 6, has the same period as the GPS chip (˜0.97 μs-1.023 MHz), but, in contrast to the latter, it is further modulated by a digital carrier at 1.023 MHz (Binary Offset Carrier (BOC) modulation); that may correspond to the application of a further Manchester code for a mid-chip transition. For the signal acquisition step, it may be possible to neglect this further modulation, which will not therefore be taken into account in the following.

The data bit has a 4 msec period (instead of 20 msec) and is denoted in FIG. 3 by reference 4. The pseudo-random code (Pseudo Random Sequence (PRS)) is denoted by reference 5 and has a length of 4092 (4*1023) chips. Therefore, each Galileo bit may include only one PRS sequence, instead of 20 C/A sequences included in the GPS bit.

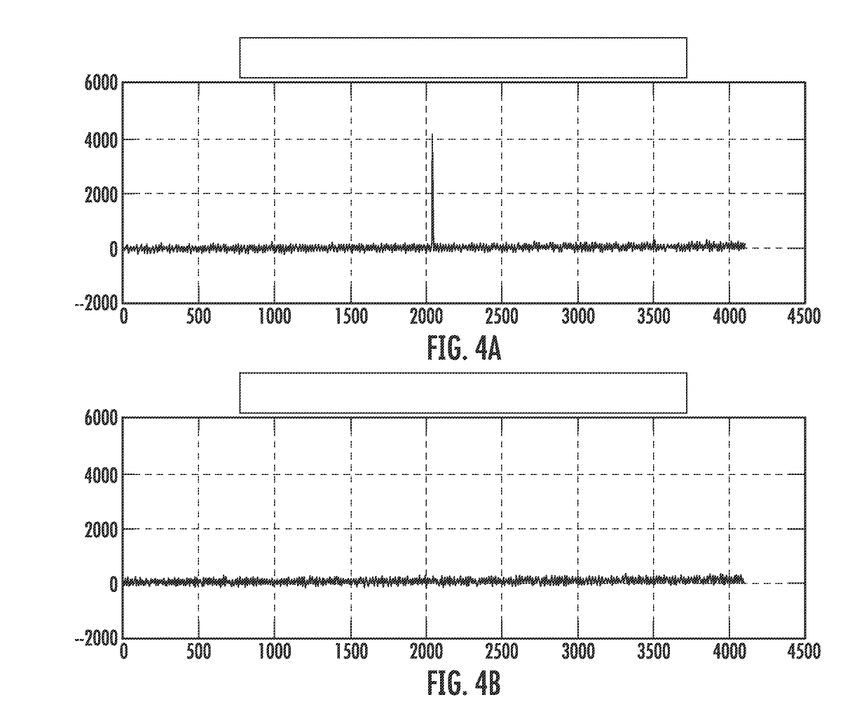

In this instance as well, the PRS codes are selected so that the self-correlation function may have a peak at zero delay and a minimum value for every other possible delay (as illustrated in FIG. 4a). The PRS codes are also selected so that the cross-correlation function among different codes is as low as possible (see FIG. 4b).

As for the receiver, such differences may be accounted for by considering that the GPS data bit (20 msec) is 5 times as long as the Galileo data bit (4 msec), and the GPS signal has shorter PRS sequences (1023 chips, i.e. 1 msec) than the Galileo signal (4092 chips, i.e. 4 msec). The differences may also be accounted for by considering that the GPS signal comprises, in one data bit, 20 PRS sequences (1023 chips each). The Galileo signal has exactly one PRS sequence (4092 chips each) for each transmitted bit.

The first task of a satellite receiver is to search and identify the satellite type, either GPS or Galileo, in the received signal. This step is often defined as the signal acquisition step. The search takes place through the correlation of the input signal with the locally generated sequences of PRS codes of the various satellites.

There is generally no intrinsic relationship between the time bases of the receiver and the transmitter. Therefore, the phase relationship between a PRS sequence possibly received and the locally generated sequence is indefinite.

In the search process a second degree of indetermination is present because of the inaccuracy of the time basis of the receiver as compared to that of the transmitter. This is due to two factors: the former is the intrinsic error of the local oscillator, and the latter is an alteration of the received signal caused by the Doppler effect. All this leads to an indetermination of the demodulation frequency to be applied to the received signal to bring the signal itself back to base-band.

For each possible PRS sequence, i.e. for every satellite, the search is therefore performed on two parameters: the demodulation frequency, and the phase of the local PRS code as compared to the received code.

Different demodulation frequencies are applied to the intermediate frequency antenna signal, to correlate the obtained signal with all possible phases of each PRS sequence. The correlation value is recorded and, at the end of the process, if a correlation value is found that is higher than the others, it is deemed that the signal of a satellite has been identified.

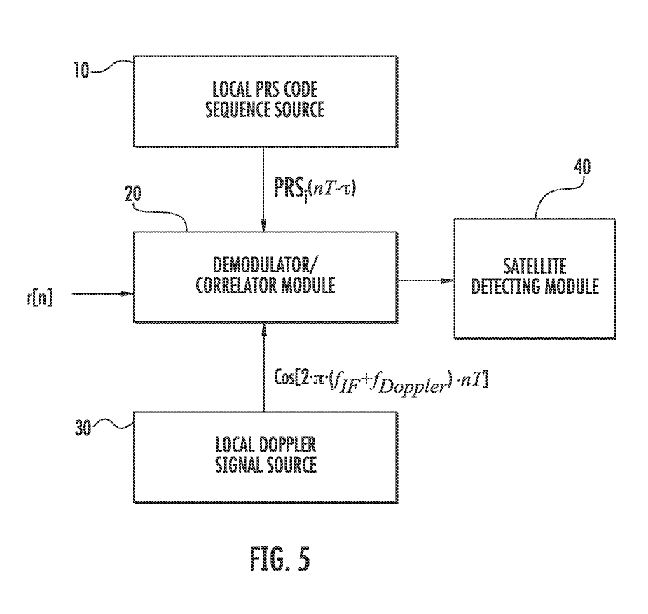

FIG. 5 shows a principle diagram of the acquisition system, wherein r[n] stands for the antenna signal, modulated at intermediate frequency and sampled (e.g. at 2.046 MHz), defined by the following equation:

$$r [ n ] = \sqrt{2 P} \cdot {C}_{i} ( {nT}_{s} - τ ) \cdot {D}_{i} ( {nT}_{s} - τ ) \cdot cos [ 2 \cdot π \cdot ( {f}_{IF} + {f}_{Dop} ) \cdot {nT}_{s} + φ ]$$

wherein the following symbols are used:

r[n]: n^{th} sample of the antenna signal,

Tₛ: signal sampling period,

P: signal power,

Cᵢ: i^{th} chip,

Dᵢ: k^{th} data bit,

f_{IF}: rated intermediate demodulation frequency,

f_{Dop}: intermediate frequency shift caused by the Doppler effect,

τ: delay of the received signal with respect to the transmitted signal, due to the signal propagation from the satellite to the receiver, and

φ: arbitrary phase of the local oscillator for base-band modulation.

Module 20 operates as a demodulator-correlator and receives, from a source 10, a local PRS code sequence PRSᵢ (nT−τ) and from a source 30 the local Doppler signal

Cos [2π(f_{IF}+f_{Doppler})nT].

The signal transmitted from the satellite is demodulated by a radiofrequency device at an intermediate frequency, f_{IF}. The relative speed between the satellite and the receiver, however, because of the Doppler effect causes the actual intermediate frequency to be different from the rated intermediate frequency by an amount f_{Dop}. The local oscillator used to bring the signal from intermediate frequency to base-band is therefore programmed at the actual oscillation frequency that amounts to the sum of the rated frequency and the Doppler variation.

The output of module 20 is fed to a satellite detecting module 40. Module 40 compares the correlation functions between the input signal and the locally generated PRSᵢ signals, and identifies the satellite that sent the input signal.

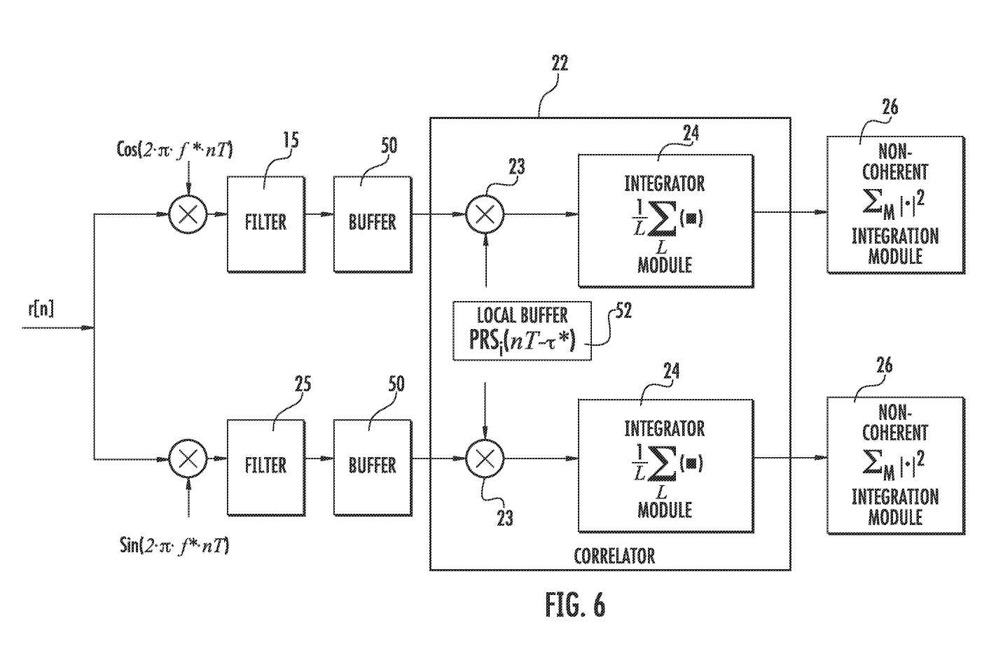

Referring to FIG. 6, the operation of the correlator 22 included in the module 20 is described in more detail. The signal r[n] is fed to two parallel branches, that, in turn, are fed to the correlator 22. On the first branch (upper part in FIG. 6) the signal r[n] is multiplied by the signal Cos(2πf*nT) and input into a first low-pass filter 15, while on the second branch (below in FIG. 6), the signal is multiplied by the signal Sin(2πf*nT) and input into a second low-pass filter 25. The outputs of the two low-pass filters 15 and 25 are fed to the correlator 22. Both branches are multiplied in a respective multiplication node 23 for the locally generated PRS, signal (nT−τ*). The signals thus derived are input into two integrator modules 24, that perform a coherent integration

$$\frac{1}{L} {\sum }_{L} ( • ) .$$

The outputs of the two integrator modules 24 are fed in turn to two modules 26, that perform a non-coherent integration Σ_{M}|•|².

In keeping with the exemplary assumption of a sampling frequency of 2.046 MHz, there are two samples for each chip, and therefore 2046 possible phases between the assumed received PRS sequence and the locally generated sequence. The first process of coherent accumulation, performed by the modules 24, takes place in the correlator 22, and is followed by a power accumulation of the non-coherent signal, carried out by the modules 26, to highlight the presence of possible correlation peaks, without excessively decreasing the pass-band of the system.

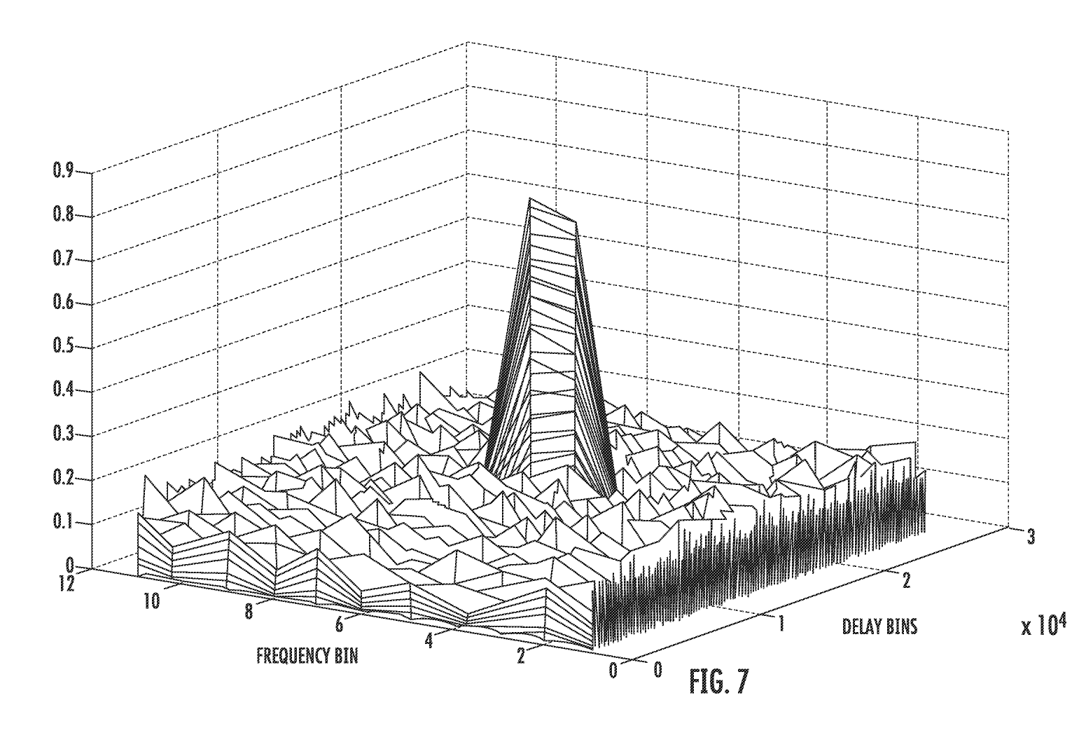

By performing a search in the solution search space, defined by f* and τ*, a map is obtained that, in the case of presence of a satellite, appears approximately as shown in FIG. 7, i.e. as a tridimensional function with two horizontal coordinates definable as frequency bins and delay bins, and one vertical coordinate expressing the correlation.

The question of the acquisition step efficiency can be more thoroughly understood by referring to the following numerical example. Let us assume, for example, a sampling frequency of 2.046 MHz (i.e. amounting to two samples per chip) and an uncertainty of 10 KHz for the demodulation frequency. Let us assume, moreover, a coherent integration time of 1 ms (approximately ˜1 KHz pass-band) and a non-coherent integration time of 10 ms (in practice this time can be much higher as well).

By defining, in this instance, a solution search space comprising 2046 phases, 20 frequencies (e.g. with a search grid of approx. 500 Hz), 10 ms per dot, the acquisition would take an average of 409.2 seconds (2046*20*10 ms) per satellite, i.e. nearly 7 minutes, to be repeated for each possible satellite (for a maximum of 32 satellites currently deployed). The search for signals would therefore attain unacceptable times.

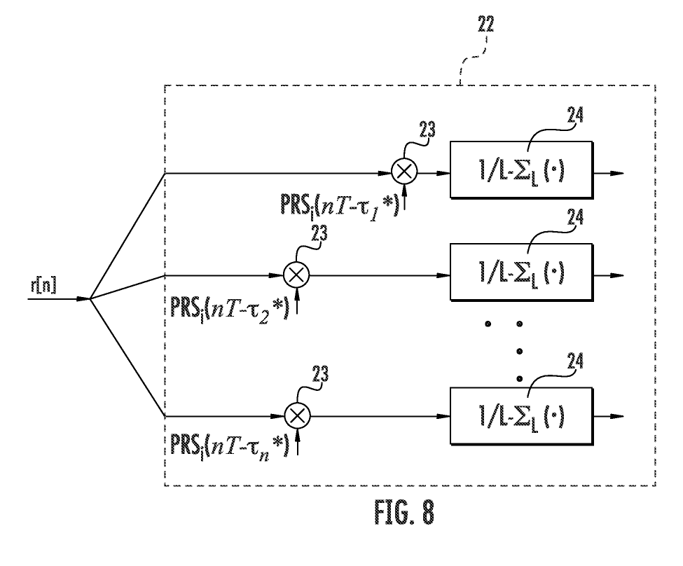

It may be possible to perform several correlations simultaneously, for example, by searching in parallel all possible phases of the PRS code, as sketched in FIG. 8. The correlator illustrated in FIG. 8 is also known as parallel correlator, or “flash” correlator. In such a correlator, on each branch the input signal r[n] is multiplied, through multiplication nodes 23, for a different, locally generated replica of the signal PRSᵢ(nT−τⱼ*) (with j=1 . . . n). The resulting signals are input into the integrator modules 24, that perform in a parallel fashion the coherent integration

$$\frac{1}{L} {\sum }_{L} ( • ) .$$

Due to the high number of calculations to determine the correlation function, the most convenient solution may include performing them through hardware, by resorting to circular correlation.

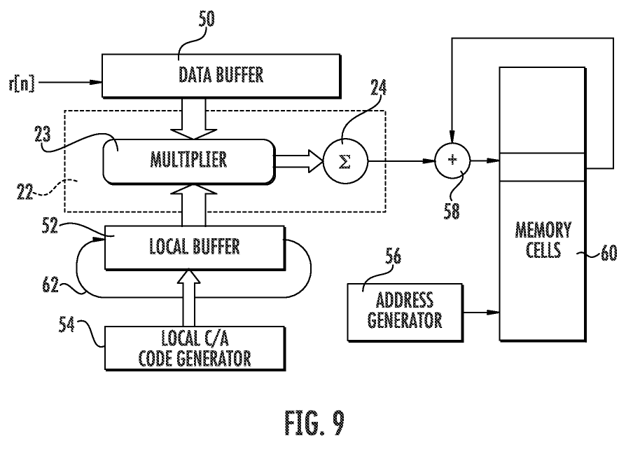

Referring to FIG. 9, N samples of the input signal r[n] are stored in a buffer 50, adapted to store them for a subsequent correlation thereof, by a hardware correlator 22 of a parallel type, that comprises N multipliers 23 and N integrator modules 24. The correlation takes place with a PRS sequence segment of a similar size, stored in a local buffer 52. The segment is obtained from a PRS sequence created by a local C/A code generator 54.

The result of the correlation operation is accumulated in a sum node 58 and stored in a memory RAM 60. The PRS sequence is then rotated by one sample, as shown by line 62, and the process starts again, until the local PRS sequence has returned to the initial condition. Then, the following data segment is loaded into the local buffer 50, and so on. The RAM memory cells 60 are selected by an address generator 56.

In this solution, because of the lack of synchronization between transmitter and receiver, the correlation can alternate with the presence of the transmitted data bit which, in case of a sign inversion, may even lead to the whole deletion of the peak, and therefore to a missing detection of the satellite. Nevertheless, in the case of a GPS signal, this sort of solution has been widely adopted, because of a potential sign transition of the data bit only every 20 C/A codes. Statistically, one of them may take place even every 40 C/A codes because the chance of a transition on the data bit amounts on average to ½. The decay of the final value of the possible correlation peak may be negligible (for example, one C/A sequence out of 20 sequences is lost).

This is no longer true for the Galileo signal. As a matter of fact, the PRS sequence in this case is present once in the data bit period. Therefore, it may be certain that, by integrating over a time corresponding to the PRS sequence (i.e. over 4 ms), a data transition will take place. This situation can be addressed by resorting to a linear correlator architecture, that allows for a reduced latency.

In the detailed analysis of the linear correlation operation, two main factors are to be monitored. For example the correlation decay due to the presence of the data bit, and the limitation of the latency time may be monitored. The linear correlation, if performed in a simple way, has a latency time corresponding to the integration time (which may be higher than, lower than or equal to the PRS code length).

To simplify the description of the correlation step, one may consider a numerical example wherein the total length of the PRS sequence is reduced, and, for example, amounts to 12 chips. The input may be a continuous flow of signal samples that may be compared to this reference sequence.

The presence of a flash correlator, i.e. a parallel correlator is assumed. The flash correlator may perform the correlation in a purely combinatorial way over a number of samples corresponding to the length of the data buffer 50 (which in any case is shorter than the PRS sequence length).

This strategy may be useful for two reasons. The first is of a practical nature, because it may not be convenient to perform the flash correlation using hardware on as many as 2046 samples. The second reason stems from the need to be able to perform a coherent correlation also over times shorter than the PRS length. The length of the used parallel correlator defines the lower limit of the time of coherent integration.

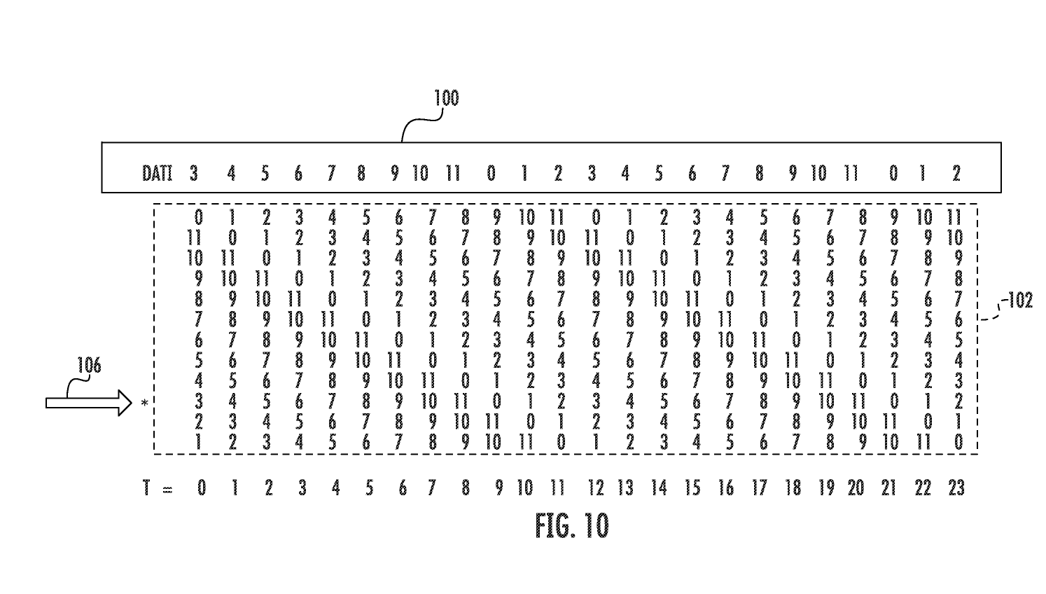

In FIG. 10, reference 102 denotes the solution search space. It graphically illustrates the data flow, by numbering from 0 to 11, the PRS sequence chips. Each line of the space 102 represents a possible phase of the locally generated sequence, which is herein represented in one sequence, wherein the phase shift is one bit for each line. The search space of the correlation solutions is therefore organized as a table 102. The rows of the table represent the versions of the local PRS binary sequence having different phases. The input signal r[n] is, on the contrary, denoted by 100, and it is shown in the first line of FIG. 10. In the example considered, the correlation peak is obtained at the line of the phase indicated by arrow 106.

In case the correlation (i.e. the accumulation) of each phase is started only at the chip identified by the number “0”, the risk of having an integration astride a possible transition of the data bit may be reduced. By resorting to this solution indiscriminately, in the case exemplified in FIG. 10, it may be desirable to wait for as many as 10 samples before starting accumulation. The result may be available at the time T=20. This may also be true in the case of integration times shorter than the PRS sequence.

In the case of integration times being shorter than the PRS sequence length, and in the case of exact sub-multiples of the same length (for example, if the PRS sequence is 1023=3*11*31 chips, it may be possible to integrate over 33 samples), the correlation can be started before the 0 index chip is generated, still ensuring the alignment with the bit edge. In such a case, the coherent correlation has a lower latency time, and an integration may not take place astride a data bit transition.

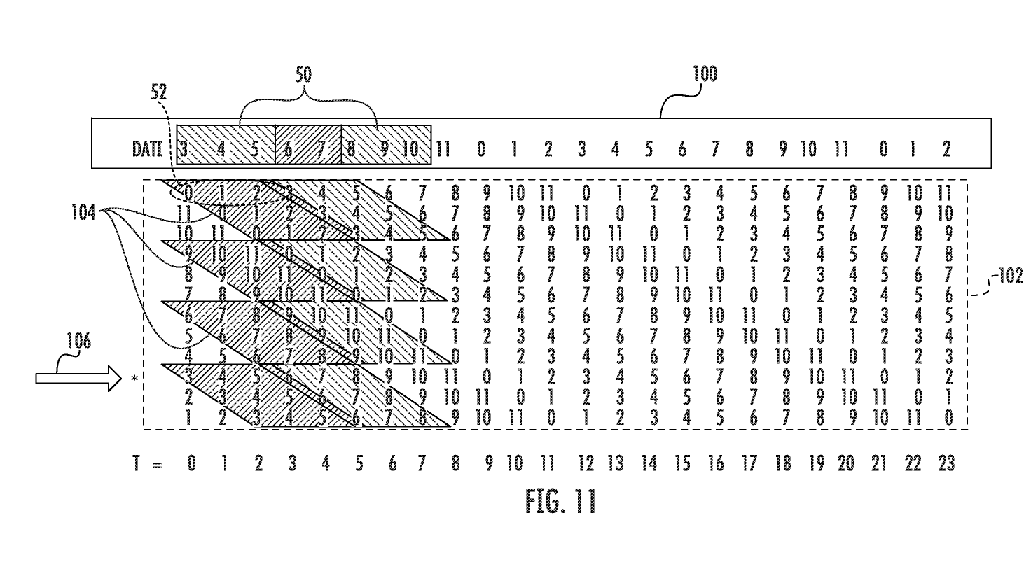

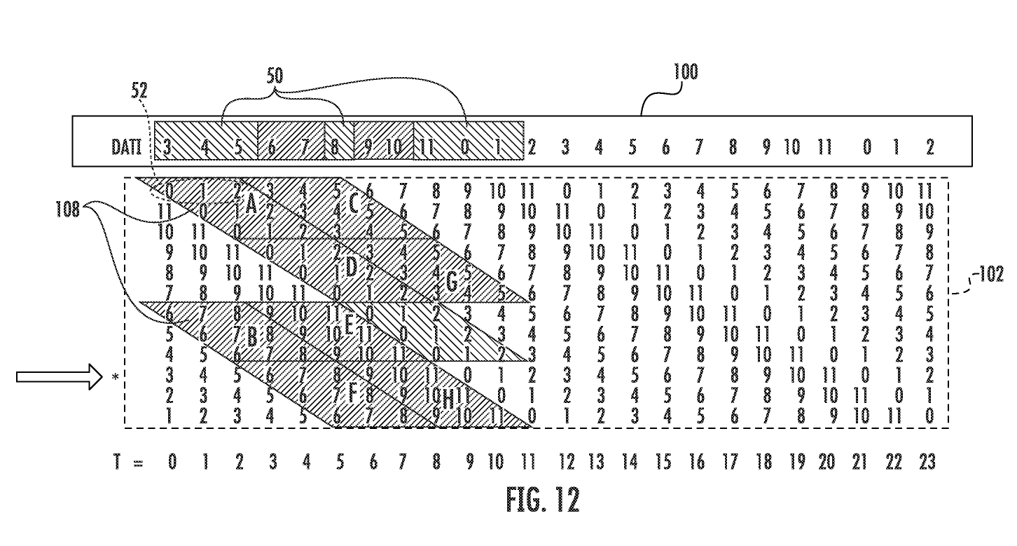

Having a parallel correlator over N samples, the N value can be selected in such a way that it is a sub-multiple of the number of samples present in a PRS sequence (in a hardware configuration, N can be chosen as amounting to (31*3)=93, but in the numerical example illustrated in FIGS. 11 and 12 N can be chosen=3). The N value selection also determines the length of the data buffers 50, which is chosen to be (2*N−1).

With the data present in the input buffer 50, it may be possible to calculate the correlation for all phases, according to the “rhomboidal” diagram described in FIG. 11. In other words, the correlation calculation is performed by executing, with a sliding window sized as the local buffer 52, a search of the subsets 104 of the solution search space 102 according to a lexicographical order, i.e. with the window sliding (from left to right in the considered example) while passing from a line to the following, with a periodic return to a new line. In the case illustrated in FIG. 11, the period of return to a new line is equal to N, i.e. it takes place every 3 lines.

In this way, the time to wait for the result is decreased. It may not be necessary to wait for the zero of the last sequence to start the accumulation. At the end of the first correlation, the following N samples are loaded, and the operation is repeated.

The identification of the correct moment to reset the accumulators in every phase may depend on the length of the correlation and on the phase itself. In various embodiments, the reset operation is applied to have it aligned with the bit edge, if present, or with an integer sub-multiple of the length.

The situation becomes even more complex if the coherent integration time (correlation), expressed in terms of samples, although being shorter than the number of samples included in the local PRS binary sequence, is a multiple (always in terms of samples) of the size of the hardware correlator (assuming in this numerical example that it is equal to N=3 samples). For example, in case the correlation time is 6 samples, i.e. 2N (two correlations), the calculations referring to one and the same parameter set (i.e. to the same frequency IF) can be performed by operating on the rhomboidal subsets 108 illustrated in FIG. 12, following the alphabetical order specified by the letters A, B, . . . , H.

In this case as well, the process of exploring the search space 102 involves exploring the tables 102 according to rhomboidal subsets 108A, 108B, . . . , 108H, i.e. operating by sequential lines, with windows sliding (from left to right, in the considered example) with the passage from one line to the following, with a periodic return to a new line. In this case, however, the sliding windows match a plurality of the single above-mentioned sliding windows, until, for each set of matching windows, an overall number of samples is reached which equals the correlation time (expressed as a number of samples, i.e., in the considered example wherein it was supposed that the correlation time corresponds to 6 samples, i.e. equals to 2N (two correlations). The periodic return to a new line also takes place every 6 lines, i.e. at intervals equal to the correlation time (expressed as the number of samples).

In this case, the lexicographic order is superimposed by a criterion of exploration of rhomboidal subsets 108A, 108B, . . . , 108H, for columns of subsets vertically aligned in table 102. In other words, by first of all, the subsets 108A and 108B (first column), subsequently, the subsets 108C, 108D, 108E and 108F (second column), and finally, the subsets 108G and 108H (third column). It may be possible to further reduce the dead times by executing, with the same data buffer, correlations concerning different parameters, through a suitable management of the indexes of memory 60 and of the reset instants defined by the block 70.

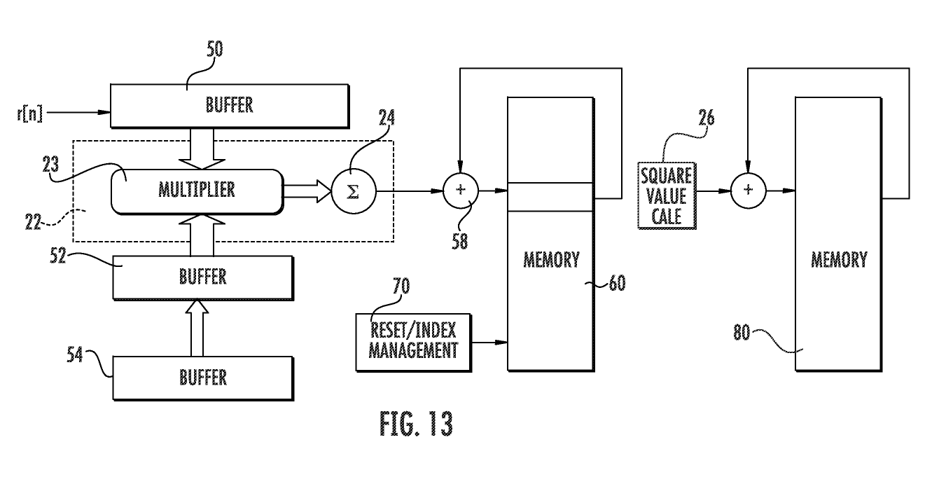

A possible hardware configuration will now be described for the block in FIG. 13, with reference to FIG. 11. Specifically, the correlation process according to the present embodiments in a first “clock stroke” include the steps of: loading in a buffer 50 (2N−1), chips of the sequence r(n), for example, the location data 3, 4, 5. The correlation process also includes loading in a buffer 54 a first local binary sequence, for example, the location data from 0 onwards. The correlation process further includes loading in a buffer 52, a subset of local binary sequence of length N, for example, the location data 0, 1, 2, performing the correlation through block 22 between the first N chips loaded in the buffer 50 (3, 4, 5) and those included in the buffer 52 (0, 1, 2), and storing the result from the correlation in a specified location of a memory 60.

At the second clock stroke, the block described in FIG. 13 performs the subsequent calculation step. Specifically, the correlation is made between N chips stored in the buffer 50, with locations from 2 to N+1 (4, 5, 6), i.e. shifted by 1 to the right, and the data in the buffer 52 (0, 1, 2) which, because of the structure of the search space, correspond to the data of the second local binary sequence shifted by 1 (second line of the rhombus). Such information is stored in a memory location following the previous one.

At the third clock stroke, the correlation is performed between N chips stored in the buffer 50 with locations from 2 to N+2 (5, 6, 7), i.e. shifted by 1 to the right, and the data in the buffer 53 (0, 1, 2) (corresponding to the third line of the rhombus) and the result is stored in a further memory location.

At the fourth clock stroke, of the three values stored in the memory 60, the module or the square value is calculated in block 26, and the result is stored in a further memory 80. If this value is relatively low, it means that the sequence has probably not been identified. If this value is relatively high, and it increases at the following clock strikes, it means that the sequence has probably been identified.

On the contrary, referring to FIG. 12, the result from the correlation of block 12 is stored in a predetermined location of a memory 60, if it is at the beginning of the rhomboidal correlation A or D. Otherwise, for example, if the correlation is at step K, it is added to the previous value.

All these strategies may be more meaningful for the Galileo system, wherein the PRS sequence is 4 times as long (4096 chips, 4 ms). Therefore the coherent integration times may be shorter than the sequence itself.

It will moreover be appreciated that, while the embodiments considered herein are based on the criterion of selecting the number N as an exact sub-multiple of the number of samples included in the PRS sequence (for example, N=93 for a sequence of 2046 samples or chips), it may be possible to choose the number N as a non exact sub-multiple of the number of samples included in the PRS sequence, and to “manage” the number of samples representative of the remainder of the division with the rhomboidal subsets 104; 108A, 108B, . . . , 108H correspondingly cut out, i.e. with the subsets regarded as rhomboidal subsets, wherein a certain number of locations may be forced to zero. Without prejudice to the underlying principle of the claimed invention, the details and the embodiments may therefore vary, even appreciably, with respect to what has been described herein by way of example only, without departing from the scope of the invention as defined by the annexed claims.

1-11. (canceled)

12. A method of acquiring a satellite signal modulated with a pseudo-random binary sequence comprising:
correlating the satellite signal with a local binary sequence including a given number of samples, the correlating being performed on a given input sequence of length 2N−1 with respect to a plurality of versions of the local binary sequence of length N having different phases and defining correlation results; and
organizing the correlation results in a table having rows representing the plurality of versions of the local binary sequence;
wherein the correlating is performed in parallel by processing a number N of samples equal to a multiple of the given number of samples by searching the table according to rhomboidal subsets by processing subsequent rows of samples with sliding windows having widths equal to the number N based upon a lexicographical order with a periodic return to a new line.

13. The method of claim 12, further comprising storing the satellite signal in a buffer having a number of samples of the satellite signal equal to 2N−1.

14. The method of claim 12, further comprising:
accumulating the correlation results for the plurality of versions of the local binary sequence; and
resetting the accumulated correlation results based upon a bit edge in the satellite signal.

15. The method of claim 12, wherein correlating comprises integrating a number of samples equal to the number N, and wherein correlating comprises searching the table based upon rhomboidal subsets and processing subsequent lines with sliding windows having a width equal to N based upon a lexicographical order with a periodic return every N lines.

16. The method of claim 12, wherein the correlating comprises integrating a number of samples equal to a multiple of the number N, and wherein correlating comprises searching the table according to the rhomboidal subsets and processing subsequent lines with sets of the sliding windows, each set including a number of windows equal to the multiple of the number N based upon a lexicographical order with a return for each number of rows equal to the multiple of the number N with a superimposed search criterion of the rhomboidal subsets in the table.

17. The method of claim 12, further comprising selecting the number N to be equal to a multiple of the given number of samples included in the local binary sequence.

18. The method of claim 12, further comprising selecting the number N to be equal to 93 for a pseudo-random binary sequence including 2046 samples.

19. The method of claim 12, wherein correlating comprises the steps of:
i) loading 2N−1 chips of an input pseudo-random binary sequence in a first buffer;
ii) loading the local binary sequence in a second buffer;
iii) loading a subset of length N of the local binary sequence in a third buffer;
iv) correlating N chips loaded in the first buffer with the subset of the local binary sequence included in the third buffer;
v) storing the correlation results in a memory location;
repeating steps from iii) to v) N times, each time shifting to the right the content of the first and third buffers;
calculating, after the N times, the modulo of each of the stored correlating results, and storing a result in an additional memory; and
if the calculated modulo is less than a given value, processing a next local binary sequence.

20. A method of acquiring a satellite signal modulated with a pseudo-random binary sequence comprising:
correlating the satellite signal with a local binary sequence including a given number of samples, the correlating being performed on a given input sequence of a length based upon a length of a plurality of versions of the local binary sequence having different phases and defining correlation results; and
organizing the correlation results in a table having rows representing the plurality of versions of the local binary sequence;
wherein the correlating is performed by processing a number N of samples based upon the given number of samples by searching the table according to rhomboidal subsets by processing subsequent rows of samples with sliding windows having widths based upon the number N based upon a lexicographical order with a periodic return to a new line.

21. The method of claim 20, further comprising:
accumulating the correlation results for the plurality of versions of the local binary sequence; and
resetting the accumulated correlation results based upon a bit edge in the satellite signal.

22. The method of claim 20, wherein correlating comprises integrating a number of samples based upon the number N, and wherein correlating comprises searching the table based upon rhomboidal subsets and processing subsequent lines with sliding windows having a width based upon a lexicographical order with a periodic return every N lines.

23. The method of claim 20, wherein the correlating comprises integrating a number of samples based upon the number N, and wherein correlating comprises searching the table according to the rhomboidal subsets and processing subsequent lines with sets of the sliding windows, each set including a number of windows based upon the number N based upon a lexicographical order with a return for each number of rows based upon the number N with a superimposed search criterion of the rhomboidal subsets in the table.

24. A correlator device for acquiring a satellite signal modulated with a pseudo-random binary sequence, the device comprising:
a parallel correlator configured to
correlate the satellite signal with a local binary sequence including a given number of samples, the correlating being performed on a given input sequence of length 2N−1 with respect to a plurality of versions of the local binary sequence of length N having different phases and defining a search space for the correlation results, and
organize the search space in the form of a table having rows representing the versions of the local binary sequence,
the correlation being performed in parallel by operating on a number N of samples equal to a sub-multiple of the given number of samples included in the local binary sequence by searching the table according to rhomboidal subsets by operating on subsequent rows of samples with sliding windows having widths equal to the number N, according to a lexicographical order with a periodic return to a new line.

25. The device of claim 24, wherein said parallel correlator is configured to store the satellite signal in a buffer having a number of samples of the satellite signal equal to 2N−1.

26. The device of claim 24, wherein said parallel correlator is configured to accumulate the correlation results for the plurality of versions of the local binary sequence, and reset the accumulated correlation results based upon a bit edge in the satellite signal.

27. The device of claim 24, wherein said parallel correlator is configured to correlate by integrating a number of samples equal to the number N, and searching the table based upon rhomboidal subsets and processing subsequent lines with sliding windows having a width equal to N based upon a lexicographical order with a periodic return every N lines.

28. The device of claim 24, wherein said parallel correlator is configured to correlate by integrating a number of samples equal to a multiple of the number N, and searching the table according to the rhomboidal subsets and processing subsequent lines with sets of the sliding windows, each set including a number of windows equal to the multiple of the number N based upon a lexicographical order with a return for each number of rows equal to the multiple of the number N with a superimposed search criterion of the rhomboidal subsets in the table.

29. The device of claim 24, wherein said parallel correlator is configured to select the number N to be equal to a multiple of the given number of samples included in the local binary sequence.

30. The device of claim 24, wherein said parallel correlator is configured to select the number N to be equal to 93 for a pseudo-random binary sequence including 2046 samples.

31. The device of claim 24, wherein said parallel correlator is configured to correlate by:
i) loading 2N−1 chips of an input pseudo-random binary sequence in a first buffer;
ii) loading the local binary sequence in a second buffer;
iii) loading a subset of length N of the local binary sequence in a third buffer;
iv) correlating N chips loaded in the first buffer with the subset of the local binary sequence included in the third buffer;
v) storing the correlation results in a memory location;
repeating steps from iii) to v) N times, each time shifting to the right the content of the first and third buffers;
calculating, after the N times, the modulo of each of the stored correlating results, and storing a result in an additional memory; and
if the calculated modulo is less than a given value, processing a next local binary sequence.

32. A non-transitory computer-readable medium comprising computer-executable instructions for
correlating the satellite signal with a local binary sequence including a given number of samples, the correlating being performed on a given input sequence of length 2N−1 with respect to a plurality of versions of the local binary sequence of length N having different phases and defining correlation results; and
organizing the correlation results in a table having rows representing the plurality of versions of the local binary sequence;
wherein correlating is performed in parallel by processing a number N of samples equal to a multiple of the given number of samples by searching the table according to rhomboidal subsets by processing subsequent rows of samples with sliding windows having widths equal to the number N based upon a lexicographical order with a periodic return to a new line.

33. The non-transitory computer-readable medium of claim 32, wherein the computer executable instructions are also for storing the satellite signal in a buffer having a number of samples of the satellite signal equal to 2N−1.

34. The non-transitory computer-readable medium of claim 32, wherein the computer executable instructions are also for:
accumulating the correlation results for the plurality of versions of the local binary sequence; and
resetting the accumulated correlation results based upon a bit edge in the satellite signal.

35. The non-transitory computer-readable medium of claim 32, wherein correlating comprises integrating a number of samples equal to the number N, and wherein correlating comprises searching the table based upon rhomboidal subsets and processing subsequent lines with sliding windows having a width equal to N based upon a lexicographical order with a periodic return every N lines.

36. The non-transitory computer-readable medium of claim 32, wherein the correlating comprises integrating a number of samples equal to a multiple of the number N, and wherein correlating comprises searching the table according to the rhomboidal subsets and processing subsequent lines with sets of the sliding windows, each set including a number of windows equal to the multiple of the number N based upon a lexicographical order with a return for each number of rows equal to the multiple of the number N with a superimposed search criterion of the rhomboidal subsets in the table.

37. The non-transitory computer-readable medium of claim 32, wherein the computer executable instructions are also for selecting the number N to be equal to a multiple of the given number of samples included in the local binary sequence.

38. The non-transitory computer-readable medium of claim 32, wherein the computer executable instructions are also for selecting the number N to be equal to 93 for a pseudo-random binary sequence including 2046 samples.

39. The non-transitory computer-readable medium of claim 34, wherein the computer executable instructions are also for:
i) loading 2N−1 chips of an input pseudo-random binary sequence in a first buffer;
ii) loading the local binary sequence in a second buffer;
iii) loading a subset of length N of the local binary sequence in a third buffer;
iv) correlating N chips loaded in the first buffer with the subset of the local binary sequence included in the third buffer;
v) storing the correlation results in a memory location;
repeating steps from iii) to v) N times, each time shifting to the right the content of the first and third buffers;
calculating, after the N times, the modulo of each of the stored correlating results, and storing a result in an additional memory; and
if the calculated modulo is less than a given value, processing a next local binary sequence.
